(19) United States
(12) Patent Application Publication
(10) Pub. No.: US 2007/0165303 A1
(43) Pub. Date: Jul. 19, 2007

(54) Fresnel lens sheet and rear projection screen

(75) Inventors: Futoshi Osawa, Tokyo-To (JP); Makoto Honda, Tokyo-To (JP)

Correspondence Address: OLIFF & BERRIDGE, PLC, P.O. BOX 19928, ALEXANDRIA, VA, 22320, US

(73) Assignee: Dai Nippon Printing Co., Ltd., Tokyo-To (JP)

(21) Appl. No.: 10/589,395

(22) PCT Filed: Nov. 22, 2005
(86) PCT No.: PCT/JP05/21450

§ 371 Date: Aug. 15, 2006

(30) Foreign Application Priority Data
Nov. 25, 2004 (JP) 2004-339849

(51) Int. Cl. G03B 21/60; G03B 21/56; G02B 3/08

(52) U.S. Cl. 359/460; 359/457; 359/742

(57) ABSTRACT

A Fresnel lens sheet for a rear projection screen that is used in combination with a single light source comprises a substrate sheet 11 and a Fresnel lens part 12 formed on the substrate sheet 11. The relationship between the haze value H (%) and the thickness T (mm) of the Fresnel lens sheet 10, measured at the center 14 of the Fresnel lens part, fulfills the following expression 1:
H≧3.15T³−23.6T²+63.8T−20.5 1.

### BACKGROUND OF THE INVENTION

1. Field of the Invention

The present invention relates to a Fresnel lens sheet and a rear projection screen, and, more particularly, to a Fresnel lens sheet that is favorably used in a rear projection screen for a projection television equipped with such a light source as an LCD or DLP.

2. Background Art

A projection television, a rear-projection-type display, is provided with a rear projection screen on which imaging light from a light source is projected. This rear projection screen usually has a Fresnel lens sheet for deflecting the imaging light projected from the light source so that the imaging light travels towards the viewer side as parallel or nearly parallel light, and a lenticular lens sheet for diffusing the parallel or nearly parallel light to increase the viewing angle. As for the light source, although a CRT light source of three-tube type, projecting light of the three primary colors from three different tubes, has been commonly used, a light source of single-tube type (hereinafter referred to as a “single light source”), using an LCD (Liquid Crystal Display) or DLP (Digital Light Processing), has come to be used to meet the recent demand for compact, high-definition, digital displays.

Although a rear-projection-type display using a single light source such as an LCD or DLP is advantageous in that it can sharply display a still image or letters by means of pixels, image displaying by pixels being a characteristic feature of displays using single light sources, it is disadvantageous in that it relatively sharply displays even a ghost image produced by stray light occurring at a Fresnel lens part. Thus, a problem with a display of this type is that an image displayed on a rear projection screen is observed as a double image.

FIG. 9 is a view showing the mechanism of double image occurrence. In a Fresnel lens sheet 90 shown in FIG. 9, a Fresnel lens 92 reflects a part of imaging light 91 from a light source, and the reflected light, stray light 93, is reflected again from a flat surface 94 on the light source side; this reflected light 95 emerges from the Fresnel lens sheet towards the observer side. The reflected light 95 produces a ghost image of the image produced by outgoing light 96 that has followed the normal light path, so that the image displayed on a rear projection screen is observed as a double image.

To reduce such a double image, there have so far been proposed some methods, such as a method that the thickness of the Fresnel lens sheet is made as small as possible to make the discrepancy between the light path of the light producing the normal image and that of the light producing the ghost image small, and a method that a diffusing agent is incorporated in the Fresnel lens sheet to make the ghost image obscure. For the latter method, the use of a haze value has been proposed in order to specify the degree of diffusion of light that is caused by the diffusing agent. In the following Patent Document 1, a method in which the range of the haze value of a Fresnel lens sheet is specified is described as a method of reducing a double image that occurs by a mechanism different from the mechanism of double image occurrence shown in FIG. 9.

Patent Document 1: Japanese Laid-Open Patent Publication No. 215716/2003.

In a high-definition rear-projection-type display using a single light source such as an LCD or DLP, there has not yet been clarified the relationship between the thickness and the haze value of a Fresnel lens sheet, which is a technical factor for double image reduction.

### DISCLOSURE OF THE INVENTION

An object of the present invention is to provide a Fresnel lens sheet for a rear projection screen that is used in combination with a single light source, capable of reducing a double image to be displayed on a screen of a rear-projection-type display for which a single light source such as an LCD or DLP is used, and also a rear projection screen using such a Fresnel lens sheet.

In order to achieve double image reduction, we fully studied the relationship between the thickness and the haze value of a Fresnel lens sheet, and found that there is a particular relationship between these two that makes it possible to achieve double image reduction. The present invention was accomplished on the basis of this finding.

The present invention is a Fresnel lens sheet for a rear projection screen that is used in combination with a single light source, comprising a substrate sheet and a Fresnel lens part formed on the substrate sheet, the relationship between the haze-value H (%) and the thickness T (mm) of the Fresnel lens sheet, measured at the center of the Fresnel lens part, fulfilling the following expression 1:
H≧3.15T³−23.6T²+63.8T−20.5 1

According to this invention, it is possible to solve the double image problem that occurs when a Fresnel lens sheet is used for a rear projection screen, if the Fresnel lens sheet is formed so that its haze value and thickness are in the above-described relationship. Namely, when the Fresnel lens sheet is thin, the discrepancy between the light path of stray light produced by the reflection of light caused in the Fresnel lens sheet and that of normal imaging light is small, so that the haze value need not be made very great, as long as it fulfills the above expression 1. On the other hand, even when the Fresnel lens sheet is thick, it is possible to attenuate stray light that causes the occurrence of a double image, if the haze value is made great so that it fulfills the above expression 1.

The present invention is the Fresnel lens sheet in which the substrate sheet contains a diffusing agent, and the haze value H (%) is determined by this diffusing agent.

The present invention is the Fresnel lens sheet in which the surface of the Fresnel lens part has irregularities, and the haze value H (%) is determined by these irregularities.

The present invention is the Fresnel lens sheet in which the substrate sheet surface opposite to that on which the Fresnel lens part is present has irregularities, and the haze value H (%) is determined by these irregularities.

The present invention is the Fresnel lens sheet including at least one of the following three means: (1) a means of a diffusing agent incorporated in the substrate sheet, (2) a means of the Fresnel lens part having on its surface irregularities, and (3) a means of the substrate sheet having on its surface opposite to the Fresnel lens part irregularities, the haze value H (%) being determined by (1) the means of the diffusing agent contained in the substrate sheet, (2) the means of the Fresnel lens irregularities, or (3) the means of the substrate sheet having irregularities.

The present invention is a rear projection screen that is used in combination with a single light source, comprising a Fresnel lens sheet for deflecting light rays from a single light source to make them nearly parallel to each other, and a light-diffusing sheet for controlling the viewing angle by diffusing the light rays that have been made nearly parallel to each other by the Fresnel lens sheet, the Fresnel lens sheet comprising a substrate sheet and a Fresnel lens part formed on the substrate sheet, the relationship between the haze value H (%) and the thickness T (mm) of the Fresnel lens sheet, measured at the center of the Fresnel lens part, fulfilling the following expression 1:
H≧3.15T³−23.6T²+63.8T−20.5 1

The present invention is the rear projection screen in which the substrate sheet contains a diffusing agent, and the haze value H (%) is determined by this diffusing agent.

The present invention is the rear projection screen in which the surface of the Fresnel lens part has irregularities, and the haze value H (%) is determined by these irregularities.

The present invention is the rear projection screen in which the substrate sheet surface opposite to that on which the Fresnel lens part is present has irregularities, and the haze value H (%) is determined by these irregularities.

The present invention is the rear projection screen wherein the Fresnel lens sheet includes at least one of the following three means: (1) a means of a diffusing agent incorporated in the substrate sheet, (2) a means that of Fresnel lens part having on its surface irregularities, and (3) a means of the substrate sheet having on its surface opposite to the Fresnel lens part irregularities, the haze value H (%) being determined by (1) the means of the diffusing agent contained in the substrate sheet, (2) the means of Fresnel lens part having irregularities or (3) the means of the substrate sheet having irregularities.

According to the present invention, the rear projection screen comprises the above-described Fresnel lens sheet of the present invention and light-diffusing sheet for controlling the viewing angle, so that it can solve the double image problem with conventional rear projection screens.

As described above, according to the Fresnel lens sheet and the rear projection screen of the present invention, it is possible to solve the double image problem that occurs when a Fresnel lens sheet is used for a rear projection screen, by clarifying the relationship between the thickness and the haze value of the Fresnel lens sheet, which is a technical factor for double image reduction. A Fresnel lens sheet whose thickness and haze value are in such a relationship, and a rear projection screen comprising such a Fresnel lens sheet can be particularly favorably used for a rear-projection-type display that displays even a ghost image relatively sharply.

### BRIEF DESCRIPTION OF THE DRAWINGS

FIG. 1 is a diagrammatical perspective view showing a Fresnel lens sheet of the present invention.

FIG. 2 is a graph showing the relationship represented by expression 1.

FIG. 3 is a diagrammatical perspective view showing a specimen for the measurement of haze value that is prepared by cutting a Fresnel lens sheet at the center portion of the Fresnel lens part.

FIGS. 4(A), 4(B) and 4(C) are diagrammatical sectional views showing three Fresnel lens sheets having adjusted haze values.

FIGS. 5(A) and 5(B) are views illustrating the effect of a Fresnel lens sheet of the present invention.

FIG. 6 is a diagrammatical view showing a rear projection screen of the present invention.

FIGS. 7(A), 7(B) and 7(C) are diagrammatical perspective views showing light-diffusing sheets that constitute rear projection screens of the present invention.

FIG. 8 is a diagrammatical view showing a rear-projection-type display on which a rear projection screen of the present invention is mounted.

FIG. 9 is a view showing the mechanism of double image occurrence.

FIG. 10 is a sectional view showing the structure of the rear projection screen that was used in Examples.

FIG. 11 is a diagrammatical view showing a manner in which a double image of cross-hatching projected on a rear projection screen surface is observed.

FIGS. 12(A) and 12(B) are views showing paths of light rays that produce a double image; FIG. 12(A) illustrates the case where a thin Fresnel lens sheet is used, while FIG. 12(B) illustrates the case where a thick Fresnel lens sheet is used.

### BEST MODE FOR CARRYING OUT THE INVENTION

A Fresnel lens sheet and a rear projection screen of the present invention will be described hereinafter with reference to the accompanying drawings.

(Fresnel Lens Sheet)

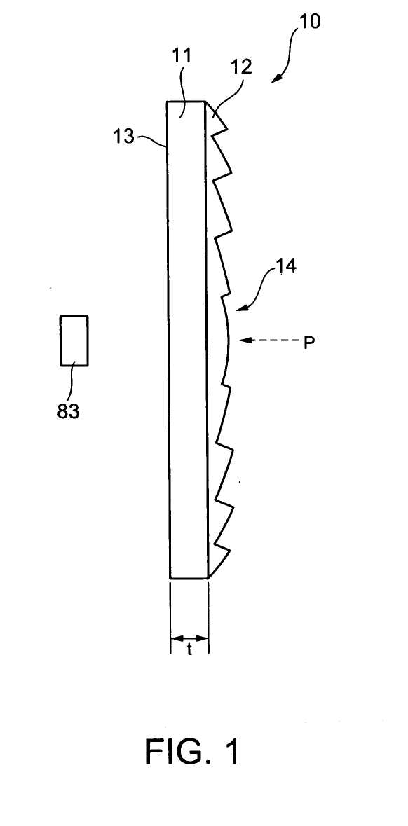

FIG. 1 is a diagrammatical perspective view showing a Fresnel lens sheet of the present invention. A Fresnel lens sheet 10 of the present invention comprises a substrate sheet 11 and a Fresnel lens part 12 formed on the substrate sheet 11. The Fresnel lens sheet 10 is a lens sheet for refracting imaging light rays projected from a light source 83 to make them nearly parallel and transmitting these light rays. The structure of the Fresnel lens sheet of the present invention will be described hereinafter.

The substrate sheet 11 is a transparent flat sheet that serves as a substrate for the Fresnel lens part 12. Since the Fresnel lens part 12 is formed by the use of a radiation-curable resin on one surface of the substrate sheet 11 stretching in the direction of thickness, it is desirable that the substrate sheet 11 transmits radiation (e.g., light, ultraviolet rays, electron beams, etc.) that is applied to the radiation-curable resin from the side of the flat surface 13 on which the Fresnel lens part 12 is not present. The flat surface 13 is the other surface of the substrate sheet 11 stretching in the direction of thickness.

Examples of the material for the substrate sheet 11 include transparent resins such as acrylic resins, styrene resins, polyester resins, polycarbonate resins, and acrylic-styrene copolymer resins. The substrate sheet 11 is made by subjecting any of these resins into extrusion molding, press molding, injection molding, cast molding, or the like. The thickness t of the substrate sheet 11 is usually in the range of 0.1 to 5 mm, and the type of the material to be used for the substrate sheet 11, the radiation transmittance of the material, and so forth are taken into consideration to determine this thickness t.

The Fresnel lens part 2 is a part having a circular Fresnel lens made up of a plurality of prisms for deflecting light rays from a light source 83 to make them nearly parallel. This Fresnel lens part 12 is formed on one surface of the substrate sheet 11 stretching in the direction of thickness so that the center P of the Fresnel lens exists on the lens surface. The Fresnel lens part 12 is made from a radiation-curable resin, and specific examples of such resins include N-vinylpyrrolidone resins, urethane resins, polyester resins, and acrylate resins.

The Fresnel lens sheet 10 is produced by the use of a molding die and a radiation-curable resin so that it deflects incident light from a light source with high accuracy. Specifically, the Fresnel lens sheet 10 is produced in the following manner: a molding die with a reverse pattern of the prisms of the Fresnel lens part 12 is prepared; after casting the above-described radiation-curable resin on the molding die, a substrate sheet 11 is placed on the cast resin, and radiation (e.g., ultraviolet light) is applied from above the substrate sheet 11 to cure the radiation-curable resin; and the molding die is then removed.

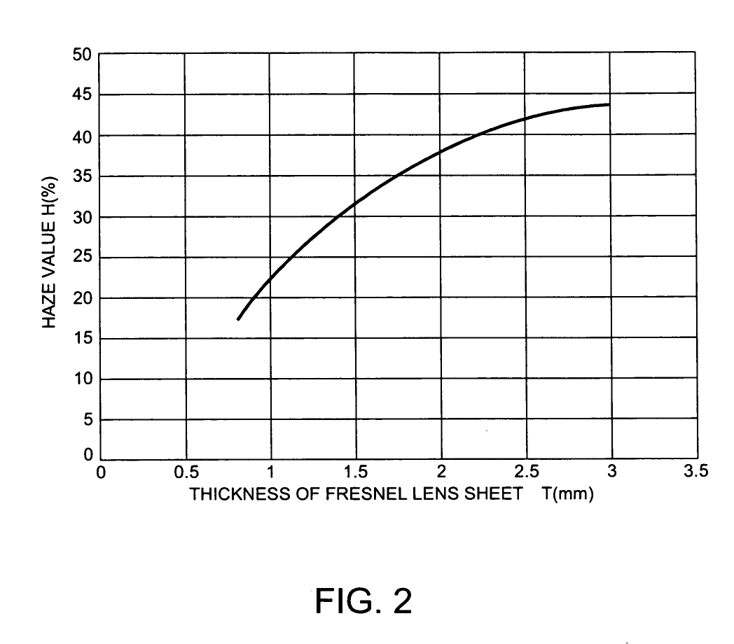

The characteristic feature of the present invention is that, in the above-described Fresnel lens sheet 10, the haze value H (%) and the thickness T (mm) of the Fresnel lens sheet 10 measured at the center 14 of the Fresnel lens part meet the relationship represented by the following expression 1:
H≧3.15T³−23.6T²+63.8T−20.5 1
FIG. 2 is a graph showing the relationship represented by expression 1.

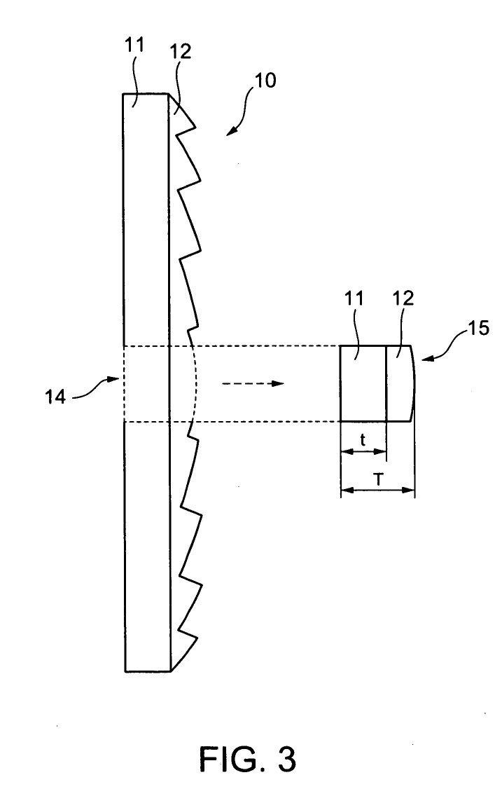

In expression 1, H is the haze value (%) of the Fresnel lens sheet 10 measured at the center 14 of the Fresnel lens part in accordance with JIS Z-7236. Specifically, a 60-mm cubic specimen 15 is prepared by cutting the Fresnel lens sheet 10 at the center 14 of the Fresnel lens part, as shown in FIG. 3, and the haze value (%) of this specimen 15 is measured with a haze meter (e.g., HR-100 manufactured by Murakami Color Research Laboratory, Japan, as described in Examples). On the other hand, T in the expression 1 is the thickness (mm) of the Fresnel lens sheet 10, measured at the center 14 of the Fresnel lens part; specifically, it is the value obtained by measuring the thickness of the above-described specimen 15.

The haze value H (%) has no upper limit. However, if the haze value H is made excessively great, the transmittance of the Fresnel lens sheet becomes low, so that the preferred upper limit of the haze value H (%) is usually about 75%, preferably 60%.

The thickness T of the Fresnel lens sheet 10 at the center 14 of the Fresnel lens part is freely determined so that it fulfills expression 1, and it can be freely determined so that it makes the haze value H not exceed its preferred upper limit described above. As mentioned previously, the thickness of the substrate sheet 11 is usually in the range of 0.1 to 5 mm, and the thickness of the Fresnel lens part 12 on the substrate sheet 11 is usually about 0.01 to 0.1 mm at the center 14 of the Fresnel lens part.

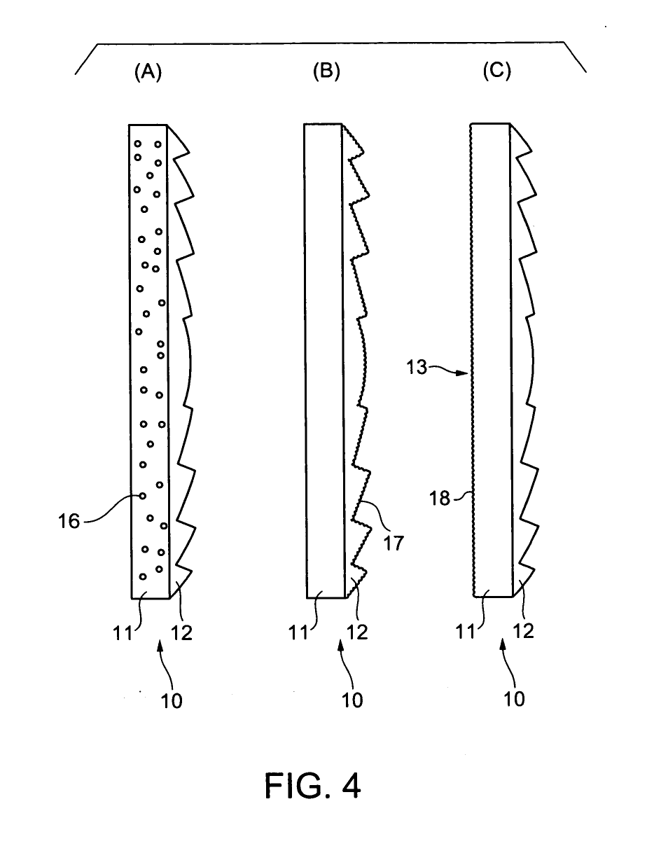

Next, a method of producing a Fresnel lens sheet whose haze value and thickness are in the above-described relationship will be described. FIG. 4 includes diagrammatical sectional views showing three Fresnel lens sheets having adjusted haze values.

In the Fresnel lens sheet that fulfills the above expression 1, its haze value H (%) can be adjusted by various means. One or more of the following means may be employed to adjust the haze value H: a means that a diffusing agent 16 is incorporated in the substrate sheet 11 (see FIG. 4(A)); a means that the Fresnel lens part 12 is made so that its surface has irregularities 17 (see FIG. 4(B)); and a means that the substrate sheet 11 is made so that its surface (flat surface 13) opposite to the surface on which the Fresnel lens part 12 will be formed has irregularities 18 (see FIG. 4(C)).

First, the means that a diffusing agent 16 is incorporated in the substrate sheet 11, as shown in FIG. 4(A), will be described. Any of light-diffusing agents that are commonly used for optical sheets can be used as the diffusing agent 16, and examples of light-diffusing agents useful herein include fine particles of organic materials such as those of styrene resins, those of silicone resins, those of acrylic resins, and those of MS resins (methacryl-styrene copolymer resins), and fine particles of inorganic materials such as those of barium sulfate, those of glass, those of aluminum hydroxide, those of calcium carbonate, those of silica (silicon dioxide), those of titanium oxide, and glass beads. One of or two or more of these diffusing agents may be incorporated in a resin.

The amount of the diffusing agent 16 to be incorporated in the substrate sheet 11 is adjusted so that the Fresnel lens sheet finally obtained has the desired haze value H, when measured at the center 14 of the Fresnel lens part. Even when the amount of the diffusing agent 16 incorporated is constant, the haze value H varies depending upon the type of the diffusing agent 16 used. In practice, therefore, the diffusing agent 16 is incorporated in an amount determined with consideration for the type of the diffusing agent 16 to give the desired haze value H. The substrate sheet 11 containing the diffusing sheet 16 can be obtained by molding a resin material in which the diffusing agent 16 has been incorporated. The method of making the substrate sheet 11 is as mentioned above, so that explanation of this method is omitted.

Next, the means that the Fresnel lens part 12 is made so that its surface has irregularities 17, as shown in FIG. 4(B), will be described. This means includes the following method: a molding die for making the Fresnel lens part 12 is made by forming, on its surface, a reverse pattern of the desired irregularities 17; a radiation-curable resin is cast on this molding die, and the substrate sheet 11 is placed on the cast resin; radiation is applied to the resin for curing, and the cured Fresnel lens sheet is separated from the molding die. To form a reverse pattern of the desired irregularities 17 on the surface of the molding die, such a method as blasting may be employed. By changing the conditions of blasting of the surface of the molding die, it is possible to control the adjustment of the haze value H that is made by this means. A method other than blasting may also be employed to form a reverse pattern of the irregularities 17 on the surface of the molding die.

Next, the means that the substrate sheet 11 is made so that its surface (flat surface 13) opposite to the surface on which the Fresnel lens part 12 will be formed has, as shown in FIG. 4(C), irregularities 18 will be described. This means includes a method that, of the two surfaces of the substrate sheet 11, the surface (flat surface 13) on which the Fresnel lens part 12 will not be formed is subjected to so-called matting. Specifically, this method is that the substrate sheet 11 is made by the use of a roll die with a reverse pattern of the irregularities 18. To form a reverse pattern of the desired irregularities 18 on the surface of the roll die, such a method as blasting may be employed. By changing the conditions of blasting of the surface of the roll die, it is possible to control the adjustment of the haze value H that is made by this means. A method other than blasting may also be employed to form a reverse pattern of the irregularities 18 on the surface of the roll die.

By employing these means, it is possible to obtain a Fresnel lens sheet of the present invention that fulfills the above-described expression 1. To obtain a Fresnel lens sheet of the present invention, one of the means shown in FIGS. 4(A) to 4(C) may be employed; or two or more of these means may be employed in combination. Moreover, a means other than the above-described ones may also be employed. For example, a diffusing agent may be incorporated in the Fresnel lens part 12.

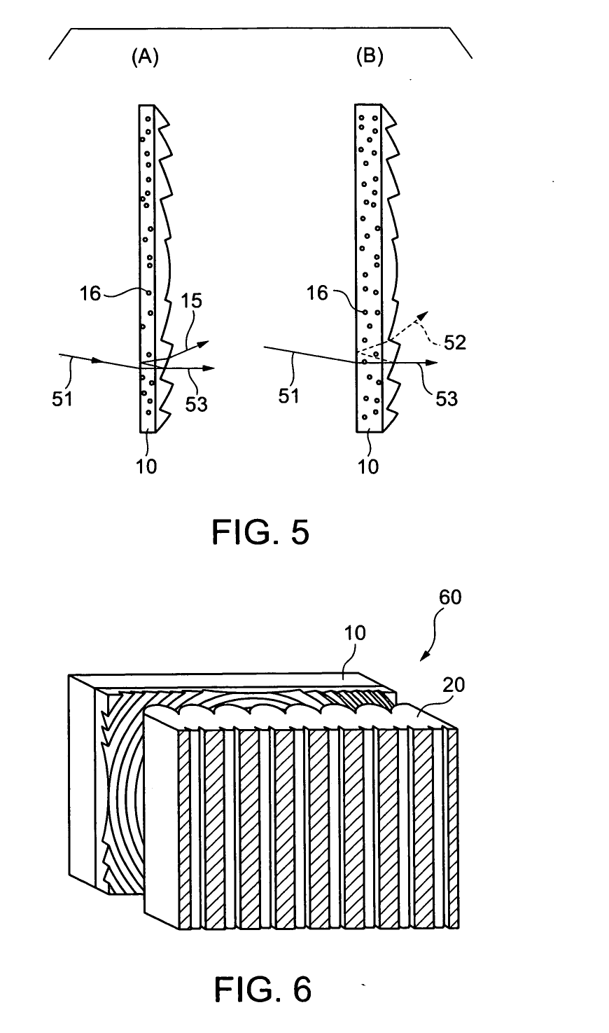

FIG. 5 is a view illustrating the effect of a Fresnel lens sheet of the present invention, and explanation will be given below with reference to a Fresnel lens sheet having a substrate sheet in which a diffusing agent has been incorporated as a means of adjusting the haze value. The Fresnel lens sheet 10 can solve the double image problem that occurs when a Fresnel lens sheet is used for a rear projection screen. Namely, as shown in FIG. 5(A), in the case where the Fresnel lens sheet 10 is thin, the discrepancy between the light path of reflected light 52 produced by incident light 51 that has been reflected within the Fresnel lens sheet and emerges from it, and that of normal imaging light 53 produced by incident light 51 that has passed through the Fresnel lens sheet, is small, so that the haze value need not be made very great, as long as it fulfills the above-described expression 1. On the other hand, even when the Fresnel lens sheet 10 is thick as shown in FIG. 5(B), it is possible to attenuate stray light, which causes the occurrence of a double image, to decrease the amount of the reflected light 52 that emerges from the Fresnel lens sheet 10, by making the haze value so great that it fulfills the above-described expression 1.

(Rear Projection Screen)

FIG. 6 is a diagrammatical view showing a rear projection screen of the present invention. A rear projection screen 60 of the present invention comprises the above-described Fresnel lens sheet 10 for deflecting light rays from a single light source to make them nearly parallel to each other, and a light-diffusing sheet 20 for controlling the viewing angle by diffusing the light rays that have been made nearly parallel to each other by the Fresnel lens sheet. The rear projection screen of the present invention is particularly favorably used as a rear projection screen that is used in combination with a single light source, because the Fresnel lens sheet 10 fulfills the above-described expression.

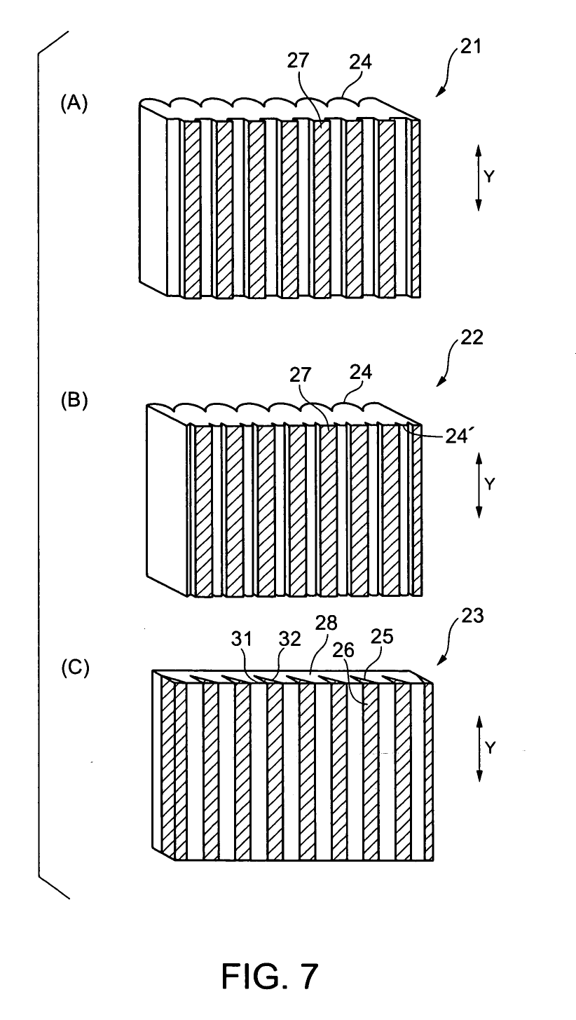

The light-diffusing sheet 20, a component of the rear projection screen 60 of the present invention, may be of any type, as long as it has the function of controlling the viewing angle by diffusing light rays that have been made nearly parallel to each other by being deflected by the Fresnel lens sheet 10. FIG. 7 includes diagrammatic perspective views showing examples of the light-diffusing sheet constituting the rear projection screen of the present invention. The Fresnel lens sheet can be freely combined with, for example, a lenticular lens sheet 21 having, on one surface, cylindrical lenses 24 (see FIG. 7(A)), a lenticular lens sheet 22 having, on both surfaces, cylindrical lenses 24, 24′ (see FIG. 7(B)), or a lenticular lens sheet 23 having, on one surface, a large number of nearly V-shaped grooves 25 filled with a resin that contains light-absorbing particles and forms low-refractive-index parts 26 (see FIG. 7(C)).

More specifically, the lenticular lens sheet 21 shown in FIG. 7(A) is as follows: on the surface on which light will be incident, a large number of cylindrical lenses 24 extending in the vertical direction Y are juxtaposed to each other with a constant pitch, while, on the surface from which light will emerge, a BS (black stripe) pattern 27 serving as a light-shielding part is formed so that the stripes are positioned, with a constant pitch, on those portions not corresponding to the light paths. Since a lenticular lens sheet 21 of this type is usually thin, a backing sheet may be further laminated, with an adhesive layer, to the surface of the lenticular lens sheet surface from which light will emerge, although not shown in FIG. 7(A). The adhesive layer to be used for this purpose may be made from an acrylic adhesive, for example. The backing sheet has rigidity sufficient to prevent the lenticular lens elements from warping so that an displayed image is not distorted, and it is a light-transmitting transparent or semi-transparent sheet-shaped member, for example. Examples of resin materials useful for the backing sheet include thermoplastic resins such as acrylic resins, polycarbonate resins, vinyl chloride resins, styrene resins, cellulose resins, and cycloolefin resins.

The lenticular lens sheet 22 shown in FIG. 7(B) is as follows: on both surfaces, a large number of cylindrical lenses 24, 24′ extending in the vertical direction Y are juxtaposed to each other with a constant pitch. On the surface from which light will emerge, a BS (black stripe) pattern 27 serving as a light-shielding part is formed so that the stripes are positioned between two adjacent cylindrical lenses 24, 24′. A lenticular lens sheet 22 of this type is commonly thicker than the lenticular lens sheet 21 shown in FIG. 7(A), so that it is usually used as it is. If necessary, however, a backing sheet may be further laminated, with an adhesive layer, to the surface of the lenticular lens sheet from which light will emerge, in the same manner as in the above-described case.

The lenticular lens sheet 23 shown in FIG. 7(C) has, on its surface from which light will emerge, a large number of nearly V-shaped grooves 25 filled with a resin that contains light-absorbing particles and forms low-refractive-index parts 26. Since a lenticular lens sheet 23 of this type is usually thin, a backing sheet is further laminated, with an adhesive layer, to the surface of the lenticular lens sheet from which light will emerge, although not shown in FIG. 7(C). The non-groove part of this lenticular lens sheet 23 is a high-refractive-index part 28, and the slant faces that define each groove 25 are an interface between the low-refractive-index part 26 and the high-refractive-index part 28. The slant faces are made up of a first slant face 31 and a second slant face 32, and these slant faces 31, 32 function as a so-called light guide whose totally reflective surface (the first slant face 31 and the second slant face 32) directs, to certain directions, light rays that have been made nearly parallel to each other by being deflected by the Fresnel lens part, and let them emerge from the lenticular lens sheet. The low-refractive-index parts 26 containing a light-absorbing resin act to improve image contrast by absorbing not only stray light occurring in the rear projection screen but also extraneous light.

These lenticular lens sheets 21, 22, 23 are usually made by extrusion-molding thermoplastic resins, or molding ultraviolet-curing resins. For example, they are produced by the use of an extrusion-molding roll whose periphery is provided with a molding die with a reverse pattern of the cylindrical lenses. Diffusing agents may be incorporated in the lenticular lens sheets, and any of the various diffusing agents mentioned in connection with the Fresnel lens sheet can be used. A lenticular lens sheet containing a diffusing agent is preferred because it acts to increase the viewing angle also in the vertical direction and to reduce glaring (scintillation) that is significantly observed when a single light source is used.

A variety of functional layers may be formed on the surfaces of the lenticular lens sheet 21, 22, 23 from which light emerges. In general, a functional layer is formed on the outer surface of the backing sheet that has been laminated, by an adhesive, to the lenticular lens sheet surface from which light emerges. A layer selected from antireflection layers, low-reflective layers, hard coat layers, antistatic layers, anti-glaring layers, anti-staining layers, polarized light filter layers, electromagnetic wave shielding layers, and so forth can be used as the functional layer with consideration for its purpose.

Although the light-diffusing sheet 20, a component of the rear projection screen 60 of the present invention, is preferably the above-described lenticular lens sheet 21, 22, or 23, it may also be a sheet having the function of diffusing light, whose structure is different from the above-described ones.

(Rear-Projection-Type Display)

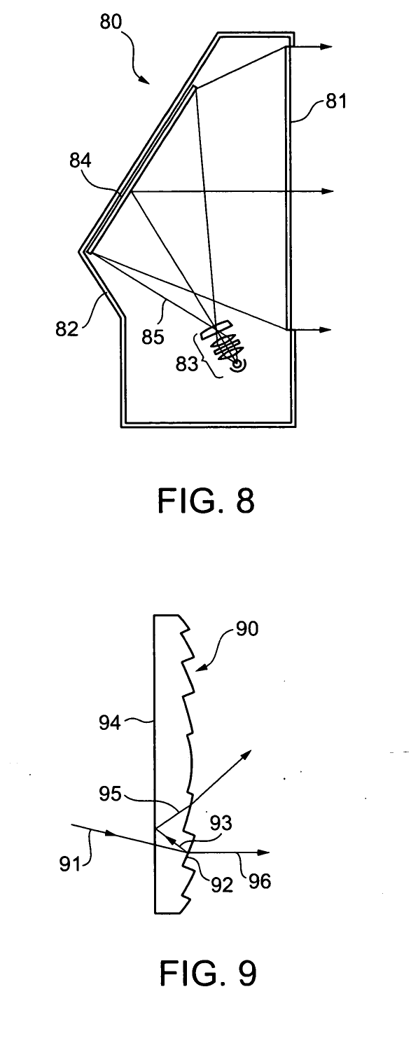

FIG. 8 is a diagrammatical view showing a rear-projection-type display on which a rear projection screen of the present invention is mounted. The rear-projection-type display 80 is as follows: a rear projection screen 81 of the present invention is mounted on a window existing on the front of the display; a light source 83 is placed on the bottom of a relatively flat body 82 of the display; and a mirror 84 for reflecting, towards the rear projection screen 81, imaging light 85 from the light source 83 is attached to the inner face of the rear wall of the body 82.

In this rear-projection-type display, it is preferred that the light source 83 be a single light source of single tube type using an LCD (Liquid Crystal Display) or DLP (Digital Light Processing). The rear projection screen 81 of the present invention can be particularly favorably used for a rear-projection-type display for which a single light source such as an LCD or DLP is used and that relatively sharply displays a ghost image as well, because the rear projection screen 81 comprises the Fresnel lens sheet of the present invention that can solve the double image problem.

### EXAMPLES

The present invention will now be specifically described by way of Examples and Comparative Examples.

### Example 1

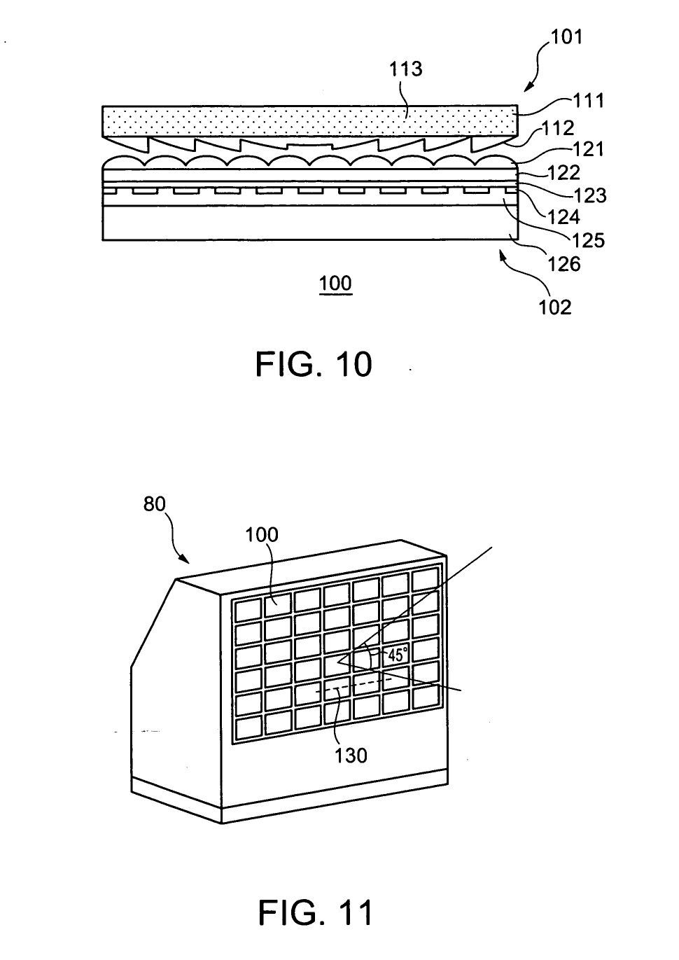

A rear projection screen 100 having a structure shown in FIG. 10 was produced. A Fresnel lens sheet 101 and a lenticular lens sheet 102 that had been produced by the following methods were assembled into the rear projection screen 100, and this rear projection screen 100 was mounted on the window, present on the viewer side, of a rear-projection-type display equipped with an LCD as a light source (see FIG. 8). In this rear-projection-type display, the size of the screen was 50 inches (aspect ratio 4:3, 762 mm long by 1062 mm broad), and the horizontal distance between the rear projection screen and the light source was 650 mm.

Production of Fresnel Lens Sheet: To produce the Fresnel lens sheet 101, a molding die with a reverse pattern of the circular Fresnel lens (pitch 0.087 mm) having its center on the sheet face was prepared, and a urethane acrylate resin, an ultraviolet-curing resin, was cast on the molding die. A substrate sheet 111 with a thickness of 0.75 mm, made from a methacryl-styrene copolymer resin containing a diffusing agent 113, was then placed on the ultraviolet-curing resin, and ultraviolet light was applied from above the substrate sheet 111 to cure the ultraviolet-curing resin, thereby forming a Fresnel lens part 112. There was thus obtained the Fresnel lens sheet 101.

The substrate sheet 111 used in this Example 1 was one obtained by extrusion-molding a high-impact methacryl-styrene resin (manufactured by Sumitomo Chemical Co., Ltd., Japan, trade name: HW, refractive index: 1.53) to which acryl beads (manufactured by Sekisui Chemical Co., Ltd., Japan, trade name: MBX-12, mean particle diameter: 12 μm, refractive index: 1.49) serving as the diffusing agent 113 had been added. To form this substrate sheet 111, the methacryl-styrene resin in which the diffusing agent 113 had been incorporated in an amount of 0.12 parts by weight for 100 parts by weight of the methacryl-styrene resin was used as an extrusion compound. The thickness of the Fresnel lens part 112, measured at its center, was 0.05 mm, and the total thickness of the Fresnel lens sheet, including the substrate sheet 111 with a thickness of 0.75 mm, was 0.80 mm.

Production of Light-Diffusing Sheet: A lenticular lens sheet 102 having cylindrical lenses 121 on its surface on which light would be incident and a BS pattern on its surface from which light would emerge was produced as the light-diffusing sheet. To form this lenticular lens sheet 102, a molding die with a reverse pattern of the lenticular lens was prepared, and a urethane acrylate resin (an ultraviolet-curing resin) was cast on the molding die, like in the production of the above-described substrate sheet 111. A polyethylene terephthalate (PET) film 122 with a thickness of 0.125 mm was then placed on the ultraviolet-curing resin, and ultraviolet light was applied from above the PET film 122 to cure the ultraviolet-curing resin, thereby forming the lenticular lens 121. The thickness of the lenticular lens sheet, defined as the distance between the apex and the opposite face of the cylindrical lens, was 0.2 mm.

Subsequently, a photosensitive, pressure-sensitive adhesive layer 122 made from an acrylic resin was formed on the surface of the PET film on which the lenticular lens 121 was not present, and ultraviolet light was applied to the adhesive layer 122 from the lenticular lens 121 side. A carbon sheet was then laminated to the surface of the photosensitive, pressure-sensitive adhesive layer to which ultraviolet light had been applied, and then removed. In this process, the portions of the photosensitive, pressure-sensitive adhesive layer through which the ultraviolet light converged by the lenticular lens 121 had passed lost their tackiness, so that the carbon was not transferred to these portions; while the other portions of the photosensitive, pressure-sensitive adhesive layer retained their tackiness, so that the carbon was transferred to these portions to form thereon carbon-transferred layers 124. These carbon-transferred layers 124 form a BS pattern. Subsequently, an acryl polymer pressure-sensitive adhesive was applied to the BS-pattern-formed face to form an adhesive layer 125, and a backing sheet 126 was laminated to this adhesive layer 125. The backing sheet 126 was obtained by extrusion-molding a high-impact methacryl-styrene resin (manufactured by Sumitomo Chemical Co., Ltd., Japan, trade name: HW, refractive index: 1.53) to which acryl beads (manufactured by Sekisui Chemical Co., Ltd., Japan, trade name: MBX-12, mean particle diameter: 12 μm, refractive index: 1.49), a diffusing agent, had been added in an amount of 2 parts by weight for 100 parts by weight of the methacryl-styrene resin. Thus, a lenticular lens sheet 102 serving as the light-diffusing sheet was produced.

### Examples 2 to 12 and Comparative Examples 1 to 6

Rear projection screens of Examples 2 to 12 and those of Comparative Examples 1 to 6 were produced in the same manner as in Example 1, except that the substrate sheet 111 constituting the Fresnel lens sheet 101 was replaced with a substrate sheet 111 with a thickness shown in Table 1, and that the diffusing agent 113 was incorporated in this substrate sheet 111 in an amount shown in Table 1.

(Evaluation)

Measurement of Haze Value: The haze value H of each Fresnel lens sheet was measured by using a 60-mm cubic specimen prepared by cutting the Fresnel lens sheet at the center portion of the Fresnel lens part (see FIG. 3). The measurement was made with a haze meter (manufactured by Murakami Color Research Laboratory, Japan, trade name: HR-100) in accordance with JIS-K-7236. The results are shown in Table 1.

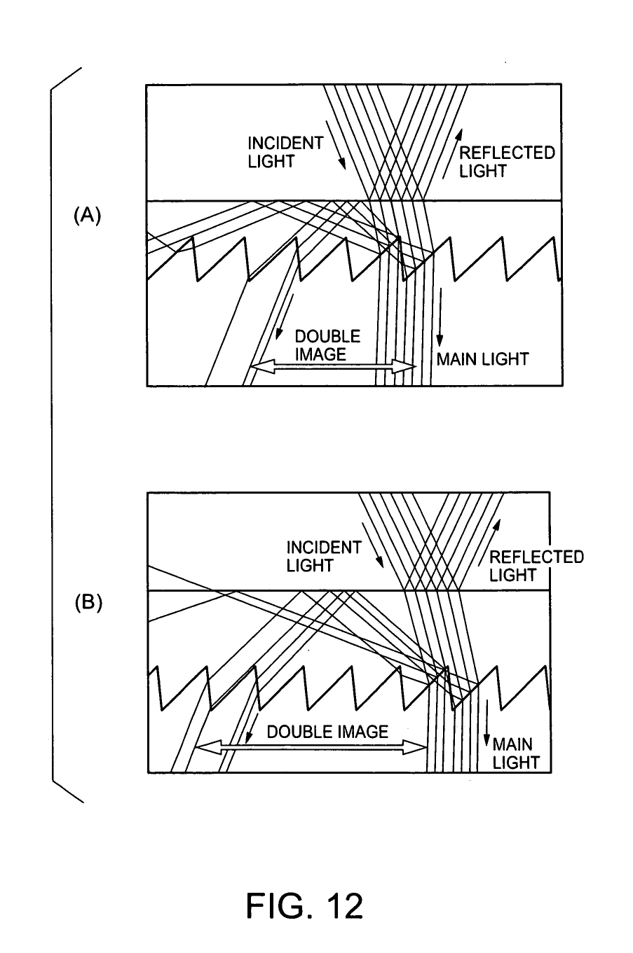

Discrepancy between Main Image and Ghost Image, and Sharpness: A white cross-hatching image on a black background was displayed on the rear projection screen 100 mounted on a rear-projection-type display 80, as shown in FIG. 11. The lower part of the rear projection screen 100 was obliquely viewed from above at an angle of 45 degrees, the horizontal distance between the viewpoint and the rear projection screen being 1 meter, to observe the double image of the cross-hatching displayed on the rear projection screen 100. The double image was made up of the cross-hatching image produced by the main light and the cross-hatching image produced as a ghost image 130, and the discrepancy between these two images was measured with a metal measure. The results are shown in Table 1. Further, the sharpness of the double image displayed was evaluated. The relative evaluation of the sharpness was made based on whether the double image was sharply viewed or not, and the sharpness of the double image was rated on a scale of 1 to 10, giving a point closer to 1 to a sharper double image, and a point closer to 10 to a more obscure double image. The results are shown in Table 1. FIG. 12 includes views showing paths of light rays producing a double image; FIG. 12(A) illustrates the case where a thin Fresnel lens sheet is used and the discrepancy between the normal image and the ghost image is not significant, and FIG. 12(B) illustrates the case where a thick Fresnel lens sheet is used and the discrepancy between the two images is significant.

Overall Evaluation: By examining the results of the above-described evaluation, the rear projection screens were rated on the criteria ⊚, ⊚-◯, ◯, and Δ. The rear projection screens rated as ⊚, ⊚-◯, or ◯ were judged acceptable.

TABLE 1

| | | | | | Evaluation of double image | | |
|---|---|---|---|---|---|---|---|
| | Fresnel lens sheet | | Substrate sheet | | Discrepancy between | | |
| | Haze value | Thickness | Diffusing agent | Thickness | main image and ghost | | Overall |
| | H(%) | T(%) (mm) | (parts by weight) | (mm) | image (mm) | Sharpness | Evaluation |
| Comparative | 12 | 0.8 | 0.05 | 0.75 | 2 | 1 | Δ |
| Example 1 | | | | | | | |
| Example 1 | 17 | | 0.12 | | | 2 | ◯ |
| Example 2 | 23 | | 0.20 | | | 3 | ⊚ |
| Comparative | 17 | 1.0 | 0.09 | 0.95 | 3 | 2 | Δ |
| Example 2 | | | | | | | |
| Example 3 | 23 | | 0.16 | | | 3 | ◯ |
| Example 4 | 27 | | 0.23 | | | 4 | ⊚ |
| Comparative | 27 | 1.5 | 0.15 | 1.45 | 5 | 4 | Δ |
| Example 3 | | | | | | | |
| Example 5 | 33 | | 0.22 | | | 5 | ◯ |
| Example 6 | 34.5 | | 0.26 | | | 6 | ⊚ |
| Comparative | 34.5 | 2.0 | 0.19 | 1.95 | 7 | 6 | Δ |
| Example 4 | | | | | | | |
| Example 7 | 38 | | 0.24 | | | 7 | ◯ |
| Example 8 | 40.5 | | 0.28 | | | 8 | ◯-⊚ |
| Comparative | 38 | 2.5 | 0.18 | 2.45 | 9 | 7 | Δ |
| Example 5 | | | | | | | |
| Example 9 | 41 | | 0.22 | | | 8 | ◯ |
| Example 10 | 44 | | 0.25 | | | 9 | ◯-⊚ |
| Comparative | 41 | 3.0 | 0.18 | 2.95 | 11 | 8 | Δ |
| Example 6 | | | | | | | |
| Example 11 | 44 | | 0.20 | | | 9 | ◯ |
| Example 12 | 47 | | 0.25 | | | 10 | ◯-⊚ |

1. A Fresnel lens sheet for a rear projection screen that is used in combination with a single light source, comprising:
a substrate sheet, and
a Fresnel lens part formed on the substrate sheet,
the relationship between the haze value H (%) and the thickness T (mm) of the Fresnel lens sheet, measured at the center of the Fresnel lens part, fulfilling the following expression 1:
H≧3.15T³−23.6T²+63.8T−20.5 1.

2. The Fresnel lens sheet according to claim 1, wherein
the substrate sheet contains a diffusing agent and the haze value H (%) is determined by this diffusing agent.

3. The Fresnel lens sheet according to claim 1, wherein
the surface of the Fresnel lens part has irregularities, and the haze value H (%) is determined by these irregularities.

4. The Fresnel lens sheet according to claim 1, wherein
the substrate sheet surface opposite to that on which the Fresnel lens part is present has irregularities, and the haze value H (%) is determined by these irregularities.

5. The Fresnel lens sheet according to claim 1, including at least one of the following three means: (1) a means of a diffusing agent incorporated in the substrate sheet, (2) a means of the Fresnel lens part having on its surface irregularities, and (3) a means of the substrate sheet having on its surface opposite to the Fresnel lens part irregularities, the haze value H (%) being determined by (1) the means of the diffusing agent contained in the substrate sheet, (2) the means of the Fresnel lens part having irregularities or (3) the means of the substrate sheet having irregularities.

6. A rear projection screen that is used in combination with a single light source, comprising a Fresnel lens sheet for deflecting light rays from a single light source to make them nearly parallel to each other, and a light-diffusing sheet for controlling the viewing angle by diffusing the light rays that have been made nearly parallel to each other by the Fresnel lens sheet,
the Fresnel lens sheet comprising:
a substrate sheet, and
a Fresnel lens part formed on the substrate sheet,
the relationship between the haze value H (%) and the thickness T (mm) of the Fresnel lens sheet, measured at the center of the Fresnel lens part, fulfilling the following expression 1:
H≧3.15T³−23.6T²+63.8T−20.5 1.

7. The rear projection screen according to claim 6, wherein
the substrate sheet contains a diffusing agent, and the haze value H (%) is determined by this diffusing agent.

8. The rear projection screen according to claim 6, wherein
the surface of the Fresnel lens part has irregularities, and the haze value H (%) is determined by these irregularities.

9. The rear projection screen according to claim 6, wherein
the substrate sheet surface opposite to that on which the Fresnel lens part is present has irregularities, and the haze value H (%) is determined by these irregularities.

10. The rear projection screen according to claim 6, wherein
the Fresnel lens sheet includes at least one of the following three means: (1) a means of a diffusing agent incorporated in the substrate sheet, (2) a means of the Fresnel lens having on its surface irregularities, and (3) a means of the substrate sheet having on its surface opposite to the Fresnel lens part irregularities, the haze value H (%) being determined by (1) the means of diffusing agent contained in the substrate sheet, (2) the means of the Fresnel lens part having irregularities, or (3) the means of the substrate sheet having irregularities.
